(19) United States
(12) Patent Application Publication
(10) Pub. No.: US 2022/0364911 A1
(43) Pub. Date: Nov. 17, 2022

(54) AMBIENT LIGHT SENSING USING LIGHT GUIDES

(71) Applicant: Amazon Technologies, Inc., Seattle, WA (US)

(72) Inventors: Dongtai Liu, Fremont, CA (US); Weihsin Hou, Fremont, CA (US); Thomas R. Hoffend, San Ramon, CA (US); Mengyuan Guo, Sunnyvale, CA (US); Jin Seo Park, San Jose, CA (US); Cyrus Yan Liu, Cupertino, CA (US)

(73) Assignee: Amazon Technologies, Inc., Seattle, WA (US)

(21) Appl. No.: 17/322,429

(22) Filed: May 17, 2021

(51) Int. Cl. G01J 1/04; G01J 1/42; G06F 1/16

(52) U.S. Cl. CPC G01J 1/0422; G01J 1/4204; G06F 1/1684

(57) ABSTRACT

Systems, methods, and computer-readable media are disclosed for ambient light sensing using light guides. In one embodiment, an example device may include a cover layer, a light guide, a light emitting diode disposed adjacent to an edge surface of the light guide, and an ambient light sensor disposed adjacent to the light emitting diode. The ambient light sensor may be configured to sense ambient light that propagates through the cover layer and the light guide.

### BACKGROUND

Electronic devices may include displays to present information to users. Some electronic devices may include sensors or other components, such as cameras, proximity sensors, ambient light sensors, and so forth. Some sensors may require access to an ambient environment of a device in order to determine various measurements, such as ambient light sensors when determining ambient light levels. To provide access to an ambient environment, devices may include apertures in paint and/or on bezels of the device. Such features may not only be aesthetically unpleasing, but may also result in larger device sizes, reduced display sizes, decreased sensor performance, and other issues. Accordingly, ambient light sensing using light guides may be desired.

### BRIEF DESCRIPTION OF THE DRAWINGS

FIG. 1 is a schematic illustration of an electronic device with an aperture for ambient light sensing, and an electronic device using a device light guide for ambient light sensing in accordance with one or more embodiments of the disclosure.

FIG. 2 is a schematic illustration of a difference in angles of acceptance for respective ambient light sensors of the electronic devices of FIG. 1, along with an example of reduced obstruction of ambient light sensing in devices using light guides for ambient light sensing in accordance with one or more embodiments of the disclosure.

FIG. 3 is a schematic illustration of example ambient light sensor placement with respect to other components of an electronic device in accordance with one or more embodiments of the disclosure.

FIG. 4 is a schematic illustration of an example side-sensing ambient light sensor and sensor mounting in an electronic device in accordance with one or more embodiments of the disclosure.

FIG. 5 is an example process flow and timeline for ambient light sensing using light guides in accordance with one or more embodiments of the disclosure.

FIG. 6 is a schematic illustration of a graph illustrating a target relative intensity for displays, along with sample weighting values for ambient light sensing using light guides in accordance with one or more embodiments of the disclosure.

FIG. 7 schematically illustrates an example architecture of an electronic device in accordance with one or more embodiments of the disclosure.

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar, but not necessarily the same or identical components. Different reference numerals may be used to identify similar components. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

### Overview

Electronic devices may be used to output digital content, and in some instances, to cause content to be presented at one or more display devices for consumption by users. For example, electronic devices may be content streaming devices that stream digital content, and may be configured to read one or more data storage devices to cause presentation of content stored on the data storage device. Electronic devices may include a variety of devices, such as electronic reader (“e-reader”) devices, desktop computers, portable computers, smartphones, tablet computers, televisions, wearable devices, speaker devices, and so forth that may be used to access various forms of content and other information. Such devices may include displays that are used to present information or content to users.

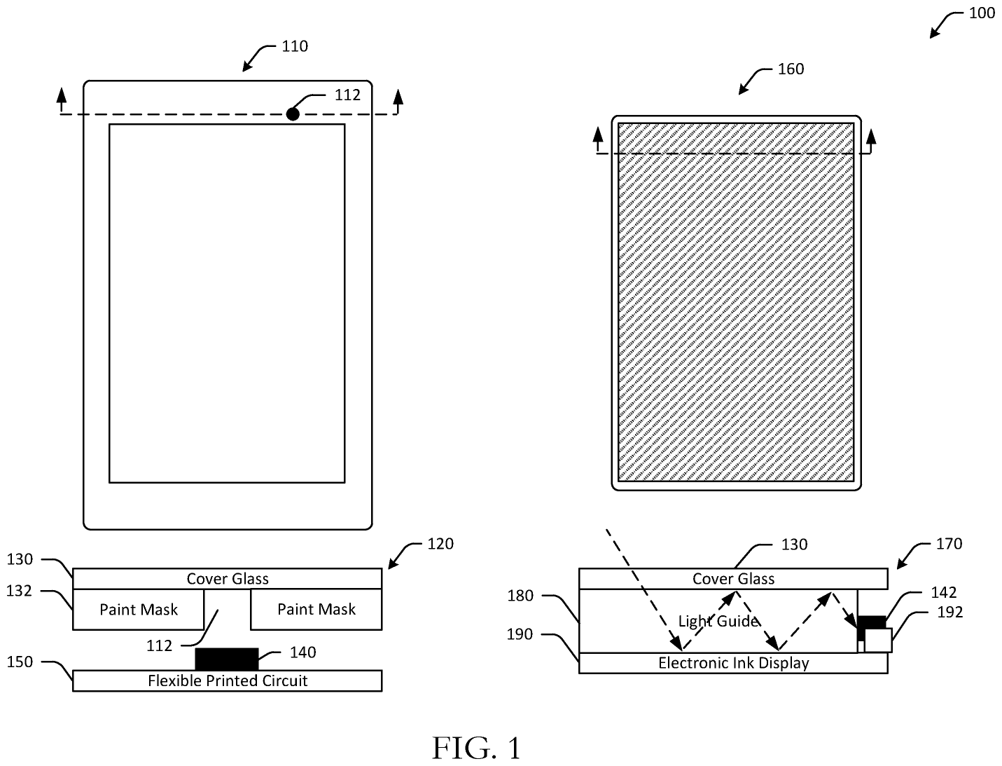

Certain electronic devices may include one or more sensors. For example, electronic devices may include one or more proximity sensors, ambient light sensors, fingerprint or other biometric sensors, cameras, and the like. Devices may include sensor apertures aligned with the sensors, where the apertures may be empty or at least partially filled with ink or paint. The sensors and/or corresponding sensor apertures may appear as dark circles or features to users viewing the device, as a result of apertures in the paint or ink used to color the device housing, device, and/or other component. This may negatively affect the aesthetic appearance of the device. Further, sensor performance may be affected due to the relatively small nature of the apertures and potential for blockage or other obstructions. In one particular example, devices with front-facing ambient light sensors, such as that illustrated in the example of FIG. 1, may be subject to blockage by user's fingers and may therefore provide inaccurate ambient light measurements.

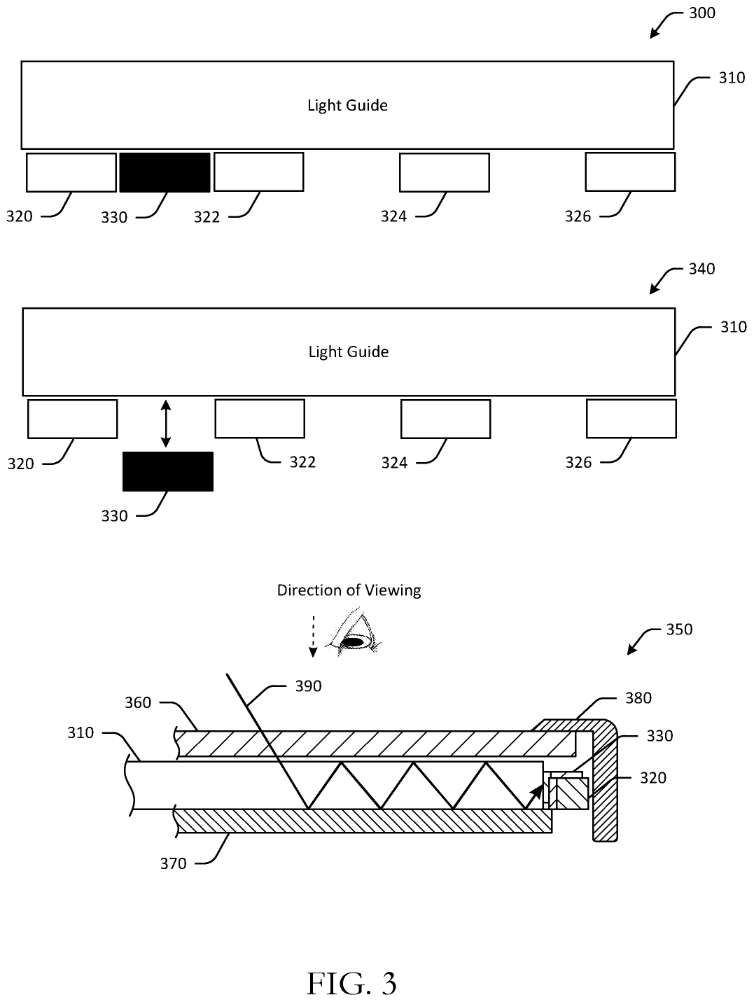

Embodiments of the disclosure include devices and display stacks that use device light guides to sense ambient light. Some embodiments include side-sensing ambient light sensors optically coupled to the light guide of a device, thereby allowing the light guide to act as a light collector for the ambient light sensor, such that ambient light propagating through the light guide can be detected by the ambient light sensor. As a result, apertures in a device bezel or other component is not necessary. Further, due to the size of the light guide relative to an aperture, sensor performance may be improved, as obstruction of the entire light guide is less likely to occur than obstruction of the entire aperture. In addition, certain embodiments may be produced with reduced complexity relative to other methods of production, and may be formed at reduced costs. Electronic devices that include ambient light sensors of the disclosure may be devoid of sensor apertures, such that users may not perceive sensor locations, and/or sensor locations may be more difficult to detect visually. Certain devices may have improved appearance as a result of the systems and methods described herein. Some embodiments may enable coexistence of ambient light sensing and LED light using time-division isolation techniques, while accounting for light pollution on the ambient light sensor. Some embodiments include ambient light sensors that are integrated into the display stack, sharing the same light path with LEDs, and using minimal bezel, as discussed with respect to FIG. 3. Embodiments may therefore provide improved device appearance, improved sensor performance, improved front lighting control, and reduced costs of production.

The techniques, methods, and processes described herein may be used to manufacture plastic and/or glass-based display stack components that can be coupled to other electronic devices. In addition, the structure and placement of ambient light sensors of certain embodiments may improve sensor performance, such as sensor field of view (e.g., angle of acceptance). As a result, device and display quality may be improved. While described in the context of light guides, aspects of this disclosure are more broadly applicable to other forms of displays and/or electronic devices.

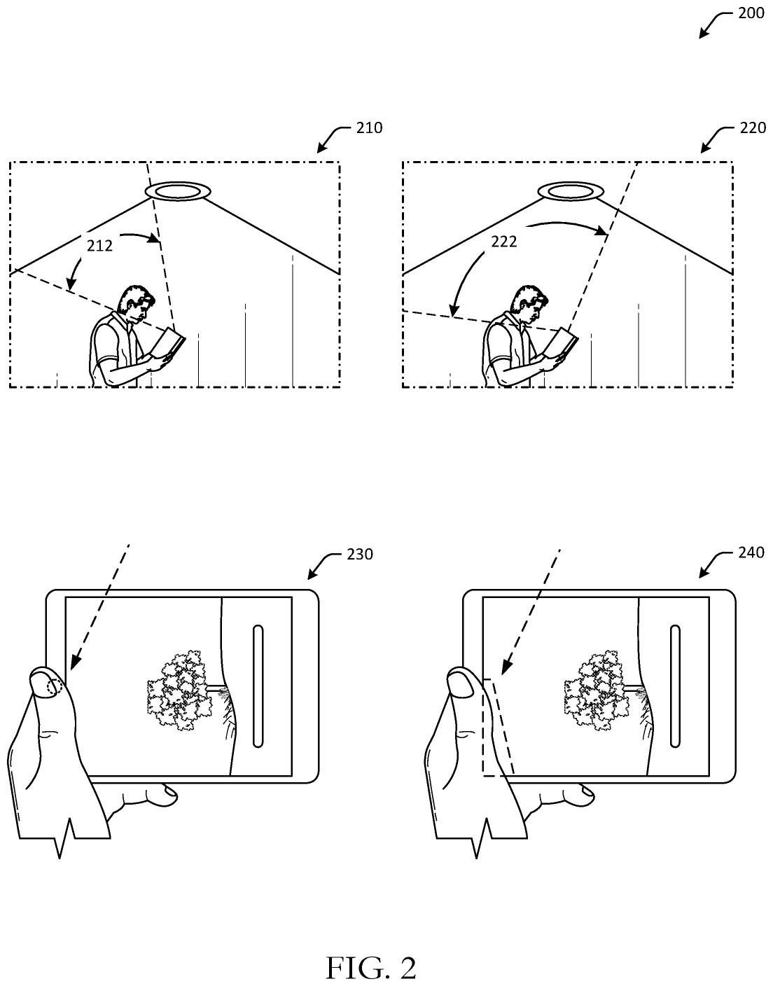

Referring to use case 100 of FIG. 1, an electronic device 110 with an aperture 112 for ambient light sensing is depicted. The aperture 112 may be aligned with an ambient light sensor 140 disposed inside a housing of the device. For example, in cross-sectional view 120 of the electronic device 110, a cover glass 130 may form an outer layer of a device (and may be part of a bezel and/or housing of the electronic device 110). A paint mask 132 may include one or more layers of paint that may be disposed adjacent to the cover glass 130. An ambient light sensor 140 may be disposed on a flexible printed circuit 150 inside the device. The flexible printed circuit 150 may be a dedicated flexible printed circuit for the ambient light sensor 140. The ambient light sensor 140 may have a sensing area disposed along an upper surface of the ambient light sensor 140. The ambient light sensor 140 may therefore sense ambient light that passes through the aperture 112 of the electronic device 110. However, the aperture 112 may not only be aesthetically unpleasing and cause dimensions of a bezel of the device to increase, the performance of the ambient light sensor 140 may be degraded due to limitations of light captured via the aperture 112, as discussed with respect to FIG. 2.

In contrast, in accordance with one or more embodiments of the disclosure, an electronic device 160 is depicted in front view and cross-sectional view 170. The electronic device 160 may include a side-sensing ambient light sensor 142 that senses ambient light using a light guide 180, and therefore does not require apertures in a bezel or housing of the electronic device 160. As a result, display size can be increased, bezel size can be decreased, and device complexity can be decreased due to elimination of a dedicated flexible printed circuit for the ambient light sensor 142.

The electronic device 160 may include a housing, one or more light emitting diodes (LEDs) 192 configured to emit light, and a display stack coupled to the housing. The display stack may include a reflective display, such as an electronic ink display 190, an LCD display, or another suitable type of reflective display. The reflective display may optionally include hardware such as drivers, support substrates, and/or other components. The light guide 180 may be coupled to the electronic ink display 190. In some instances, the light guide 180 may be coupled to the reflective display via an adhesive, whereas in other embodiments the light guide 180 may be separated from the reflective display by an air gap. The light guide 180 may be configured to propagate ambient light and the light emitted by the light emitting diode 192. The light emitting diode 192 may be optically coupled to an edge surface of the light guide 180. The device may include an optional touch sensor layer configured to receive touch input, where the touch sensor layer can be disposed on the light guide 180. Other embodiments may not include a touch sensor layer. The display stack may include a cover layer, such as the cover glass 130 or cover plastic that may be disposed on the touch sensor layer.

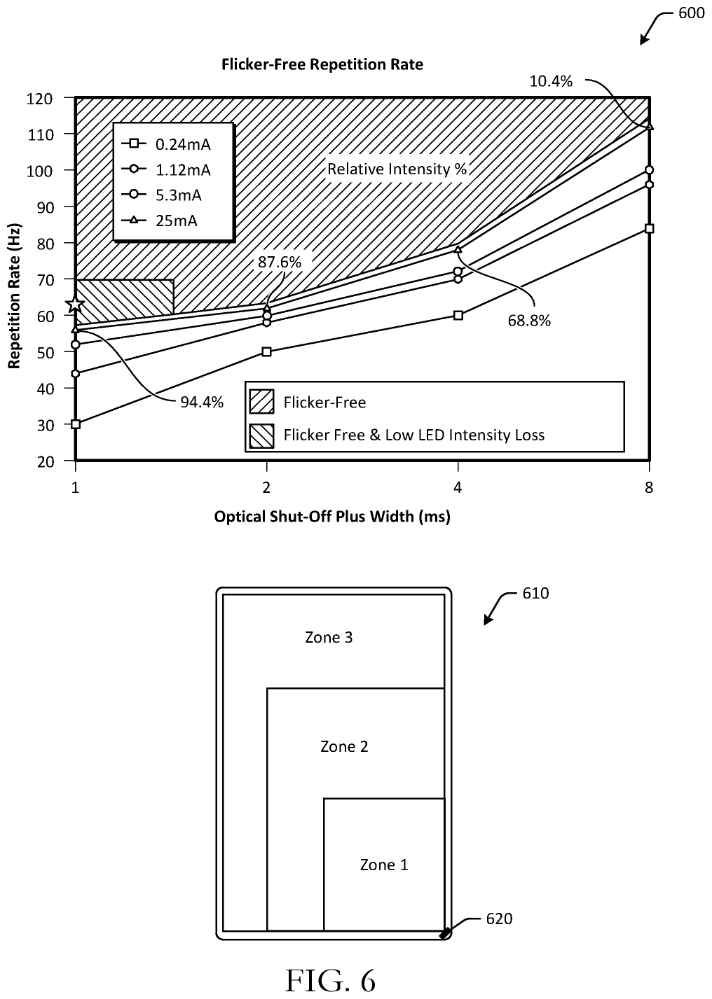

The electronic device 160 may include the ambient light sensor 142 configured to detect the ambient light that propagates through the light guide 180, where the ambient light sensor 142 may be disposed adjacent to the light emitting diode 192 and may be optically coupled to the edge surface of the light guide 180. The ambient light sensor 142 may be configured to detect ambient light at an angle of acceptance of between about 90 degrees and about 150 degrees, as discussed with respect to FIG. 2. In some embodiments, the ambient light sensor 142 may be disposed at or near a corner of the light guide, such as the position illustrated in the example of FIG. 6.

The ambient light sensor 142 may be disposed on the same flexible printed circuit on which the LEDs are disposed. The ambient light sensor 142 may have a lower surface in contact with the flexible printed circuit, and a side surface include a sensing area and a plurality of solder pads, where the ambient light sensor is electrically coupled to the flexible printed circuit using soldering disposed between the respective plurality of solder pads and the flexible printed circuit. The ambient light sensor 142, the LEDs 192, and the light guide 180 may be arranged in a coplanar arrangement, where the components are disposed on the same horizontal plane.

To detect ambient light levels, the ambient light sensor 142 may detect ambient light that propagates through the light guide 180. As a result, some or all of the light guide 180 may act as a light collector for the ambient light sensor 142, instead of a relatively small aperture as is the case for the electronic device 110. Some embodiments may enable coexistence of ambient light sensing and LED light using time-division isolation techniques, while accounting for light pollution on the ambient light sensor. Some embodiments include ambient light sensors that are integrated into the display stack, sharing the same light path with LEDs, and using minimal bezel. Embodiments may therefore provide improved device appearance, improved sensor performance, improved front lighting control, and reduced costs of production

Example embodiments of the disclosure provide a number of technical features or technical effects. For example, in accordance with example embodiments of the disclosure, certain embodiments of the disclosure may improve sensor performance, reduce device complexity and footprint, and may reduce costs to manufacture. For example, because the ambient light sensors described herein can reside on the LED flexible printed circuit, there may be no need for a dedicated flexible printed circuit/connector for the ambient light sensor, resulting in additional costs savings and reduced manufacturing complexity. The above examples of technical features and/or technical effects of example embodiments of the disclosure are merely illustrative and not exhaustive.

One or more illustrative embodiments of the disclosure have been described above. The above-described embodiments are merely illustrative of the scope of this disclosure and are not intended to be limiting in any way. Accordingly, variations, modifications, and equivalents of the embodiments disclosed herein are also within the scope of this disclosure. The above-described embodiments and additional and/or alternative embodiments of the disclosure will be described in detail hereinafter through reference to the accompanying drawings.

### Illustrative Embodiments and Use Cases

FIG. 2 is a schematic illustration of a difference in angles of acceptance for respective ambient light sensors of the electronic devices of FIG. 1, along with an example of reduced obstruction of ambient light sensing in devices using light guides for ambient light sensing in accordance with one or more embodiments of the disclosure. Other embodiments may include additional or fewer components.

In a first use case 200, a first device is depicted in illustration 210. The first device may be a device with an aperture in a bezel or elsewhere that is used to detect ambient light by an ambient light sensor disposed in the device. As illustrated in illustration 210, the ambient light sensor in the first device may have an angle of acceptance 212 that is about 80 degrees. The angle of acceptance may be an angle relative to a face of the first device at which ambient light can be detected by the ambient light sensor inside the first device. The ambient light sensor can therefore detect ambient light at an angle of acceptance 212 of 80 degrees via an aperture in the device. However, as depicted in the illustration 210, light from an external light source, such as a ceiling light, may not be fully detected by the ambient light sensor, due to the positioning of the first device. Accordingly, the ambient light sensor measurement may not be fully reflective of the ambient light level in the ambient environment, and the performance of the ambient light sensor may be limited due to the angle of acceptance 212.

In contrast, in a second use case 220, a second device is depicted in illustration 220. The second device may be a device without an aperture in a bezel, and instead senses ambient light using a device light guide via an ambient light sensor optically coupled to the light guide. As illustrated in illustration 220, the ambient light sensor in the second device may have an angle of acceptance 222 that is significantly greater than the angle of acceptance 212 of the ambient light sensor of the first device. For example, the angle of acceptance 222 may be between 90 degrees and 175 degrees, such as about 145 degrees, compared to the angle of acceptance 212 of about 80 degrees. The angle of acceptance may be an angle relative to a face of the second device at which ambient light can be detected by the ambient light sensor, where the light guide acts as a light collector and allows for ambient light to propagate through the light guide for detection by the ambient light sensor. As depicted in the illustration 220, light from an external light source, such as a ceiling light, may be fully detected by the ambient light sensor, regardless of the positioning of the second device. Accordingly, the ambient light sensor measurement may be more accurately representative of the ambient light level in the ambient environment, and the performance of the ambient light sensor may be improved due to the angle of acceptance 222. Embodiments may therefore have improved fidelity of ambient light sensing and reduced likelihood of missing dominant illumination sources, such as windows and lamps.

In another illustration 230 of the first device, the aperture used to sense ambient light can easily be blocked during use of the device, such as by the thumb of a user. In the illustrated configuration, nearly all of the ambient light may be blocked or otherwise obstructed.

In contrast, in illustration 240 of the second device, since the light guide is used for light collection, blockage of a portion of the light guide, such as that illustrated in dashed lines, may result in blockage of only about 5% of the ambient light, thereby allowing for improved readings or measurements by the ambient light sensor. This reduction in sensing error results in an improved user experience, as ambient light levels are more accurately determined and corresponding device settings, such as display brightness can be more accurately adjusted.

FIG. 3 is a schematic illustration of example ambient light sensor placement with respect to other components of an electronic device in accordance with one or more embodiments of the disclosure. Other embodiments may include additional or fewer components. The ambient light sensor and/or display stack of FIG. 3 may be the same as those discussed with respect to FIGS. 1-2.

In a first embodiment 300, a device may include a light guide 310 and a number of LEDs disposed adjacent to an edge surface of the light guide 310. For example, the device may include a first LED 320, a second LED 322, a third LED 324, a fourth LED 326, and so forth. Any number of LEDs may be included. LEDs may be disposed about one or more edge surfaces of the light guide 310. The LEDs may be side-firing LEDs and may be configured to emit light in a direction towards the light guide 310. In the first embodiment 300, the device may include an ambient light sensor 330 that is disposed adjacent to one or more LEDs, such as between the first LED 320 and the second LED 322. The ambient light sensor 330 may be disposed adjacent to any of the LEDs. In the first embodiment 300, the ambient light sensor 330 may be disposed in line with the LEDs, and may have a sensing area facing the edge surface of the light guide 310, such that light propagating through the light guide 310 is detected by the ambient light sensor 330. The ambient light sensor 330 and the LEDs may be separated from the light guide 310 by a distance of, for example, 0.35 millimeter. In some instances, a light transferring material, such as an optically clear compound, may be disposed between the ambient light sensor 330 and the light guide 310, and/or between the LEDs and the light guide 310.

In a second embodiment 340, a device may include the light guide 310 and the number of LEDs disposed adjacent to an edge surface of the light guide 310. For example, the device may include the first LED 320, the second LED 322, the third LED 324, the fourth LED 326, and so forth. Any number of LEDs may be included. LEDs may be disposed about one or more edge surfaces of the light guide 310. The LEDs may be side-firing LEDs and may be configured to emit light in a direction towards the light guide 310. In the second embodiment 340, the device may include the ambient light sensor 330 that is disposed adjacent to one or more LEDs, such as adjacent to the first LED 320 and/or the second LED 322. However, unlike the first embodiment 300, the ambient light sensor 330 may be disposed at a greater distance from the edge surface of the light guide 310 than the LEDs. For example, the ambient light sensor 330 may be disposed at a distance of about 2.25 millimeter from the edge surface of the light guide 310. The ambient light sensor 330 may have a sensing area facing the edge surface of the light guide 310, such that light propagating through the light guide 310 is detected by the ambient light sensor 330. To facilitate light detection across the increased distance, the ambient light sensor 330 may be coupled to the light guide 310 via an optically clear compound or other light transferring material.

A device having a housing 380 is partially shown in cross-sectional view 350, with the light guide 310, the LEDs 320, and the ambient light sensor 330. The device may have a third embodiment in which, unlike the first embodiment 300 and the second embodiment 340, the ambient light sensor 330 may be disposed closer to the light guide 310 than the LEDs 320. The device may include a cover layer 360, and an optional touch sensor layer coupled to the cover layer 360. The cover layer 360 and the touch sensor layer may be disposed on the light guide 310. An electronic ink display 370, such as an electrophoretic display, may be coupled to an opposite side of the light guide 310. The cover layer 360, touch sensor layer, light guide 310, and electronic ink display 370 may form, at least partially, a display stack. The display stack may be a display stack for use with an electronic reader device or other device. The device may be an e-reader device, a computer display, a portable computer, a smartphone, a tablet computer, a game console, a television, an in-vehicle display, and so forth. The display stack may form a portion of a display of the electronic device in some embodiments, or a portion of a housing of the electronic device in other embodiments. In one example, the display stack may form a portion of a touchscreen of the electronic device, where a user may touch or press a portion of the display stack to make a selection or another input.

As depicted in the example of FIG. 3, ambient light 390 may enter the light guide 310 by passing through the cover layer and optional touch sensor layer. The ambient light 390 may propagate through the light guide 310 and may reach the ambient light sensor 330. The ambient light sensor 330 may therefore detect ambient light that propagates through the light guide 310, and may not need an aperture in the housing 380 to detect ambient light levels.

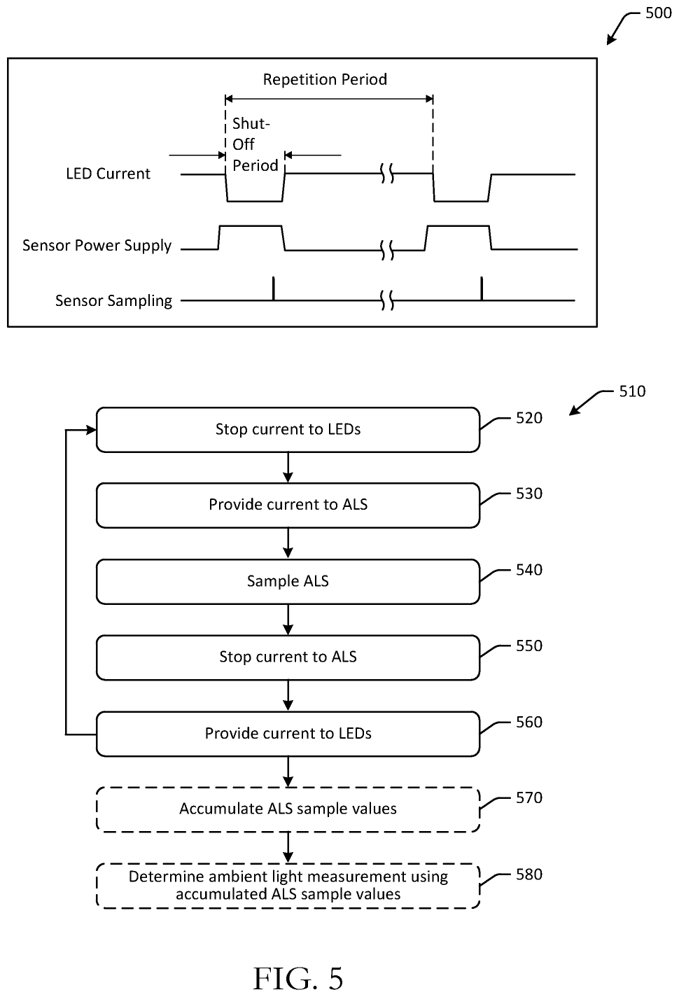

Accordingly, in some embodiments, a device may include the cover layer 360, an optional touch sensor layer, the light guide 310, at least one light emitting diode, such as the first LED 320, disposed adjacent to an edge surface of the light guide 310, and the ambient light sensor 330. The ambient light sensor 330 may be disposed adjacent to the light emitting diode 320. The ambient light sensor 330 may be configured to sense ambient light 390 that propagates through the cover layer 360, the touch sensor layer, and the light guide 310. The ambient light sensor 330 may be a side-sensing ambient light sensor, and the light emitting diode may be a side-firing light emitting diode. The ambient light sensor 330 may be configured to measure ambient light measurements while the device maintains a relative intensity of at least 70% or at least 85%, as discussed with respect to FIGS. 5-6. The ambient light sensor 330 may have an angle of acceptance of between about 90 degrees and about 150 degrees, due to the use of the light guide 310 as a light collector.

In embodiments where the ambient light sensor 330 shares a common light path with the LEDs, an ultra-narrow bezel can be used. The bezel can be devoid of openings or apertures. In addition, because the ambient light sensor 330 can reside on the LED flexible printed circuit, there may be no need for a dedicated flexible printed circuit/connector for the ambient light sensor, resulting in additional costs savings and reduced manufacturing complexity.

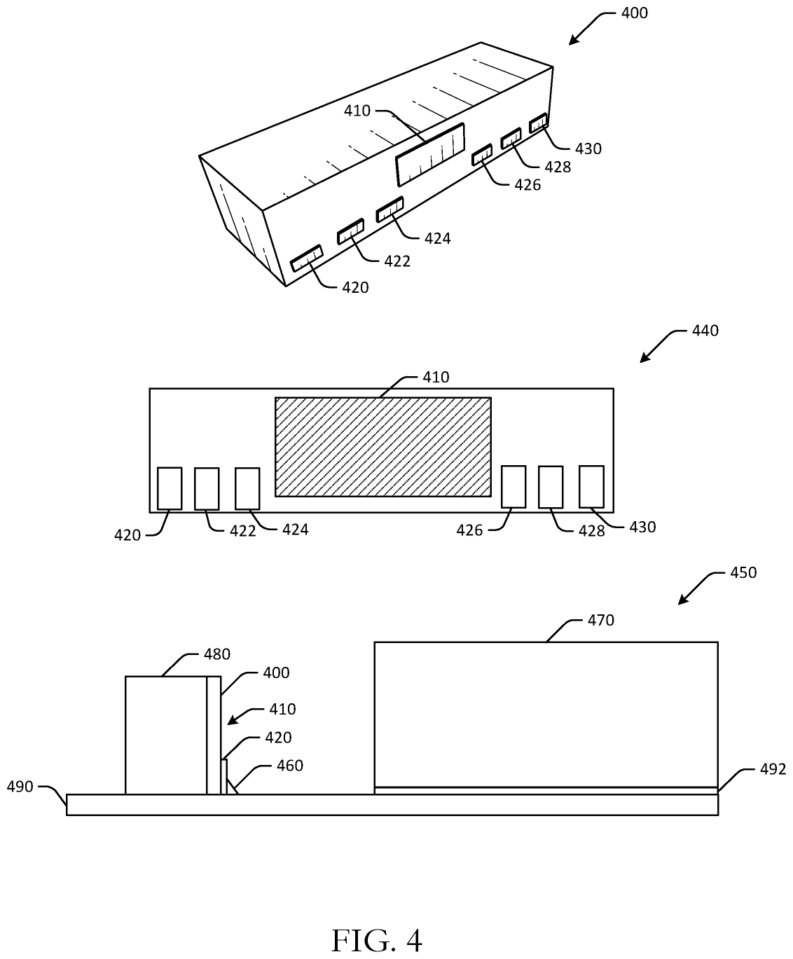

FIG. 4 is a schematic illustration of an example side-sensing ambient light sensor 400 and sensor mounting in an electronic device in accordance with one or more embodiments of the disclosure. Other embodiments may include additional or fewer components. The ambient light sensor 400 may be the same ambient light sensor as that discussed with respect to FIGS. 1-3.

The ambient light sensor 400 is depicted in perspective view and side view 440. The ambient light sensor 400 may be a side-facing or side-sensing ambient light sensor. Side-sensing indicates that the ambient light sensor 400 senses ambient light from a side surface, instead of a “top” or upper surface. Light emitting diodes used in conjunction with the ambient light sensor 400 may also be side-firing light emitting diodes.

The ambient light sensor 400 may have a sensing area 410, and one or more solder pads on a side surface. For example, the ambient light sensor 400 may include a first solder pad 420, a second solder pad 422, a third solder pad 424, a fourth solder pad 426, a fifth solder pad 428, and a sixth solder pad 430. Other embodiments may include a different number or configuration of solder pads. For example, in other embodiments, the solder pads may be on a lower surface or another side surface of the ambient light sensor 400. In other embodiments, the sensing area 410 and the solder pads may be disposed on different side surfaces. In other embodiments, the solder pads may be disposed on a different surface, such as a lower surface or a different side surface than that on which the sensing area 410 is disposed. The sensing area 410 may be used to detect photons that propagate through the light guide, where the photons represent ambient light. Side-sensing may allow for positioning of the ambient light sensor 400 adjacent to LEDs of a device, and also for sensing of ambient light without apertures in the device and/or device bezel. In some embodiments, the sensing area 410 may be a photosensitive area with a photopic filter. The ambient light sensor 400 may have a sensitivity of 5 mLux and a sensing range of 5-20 mLux.

The side surface of the ambient light sensor 400 on which the sensing area 410 is disposed may have a length of about 3 millimeters, and a height of less than or equal to 0.55 millimeter. The ambient light sensor 400 may have a depth of about 0.75 millimeter.

In a side cross-sectional view 450, the ambient light sensor 400 is depicted coupled to a flexible printed circuit 490. The ambient light sensor 400 may have a lower surface in contact with the flexible printed circuit 490, and a side surface having the sensing area 410 and a plurality of solder pads. The device may include a support 480 that may be a part of the ambient light sensor 400, or may be a discrete component.

The ambient light sensor 400 may be electrically coupled to the flexible printed circuit 490 using soldering elements 460 disposed between the respective plurality of solder pads and the flexible printed circuit 490. For example, the ambient light sensor 400 may be coupled to the flexible printed circuit 490 using six solder elements 460 disposed between the respective solder pads and the flexible printed circuit 490. In some embodiments, such as that illustrated in FIG. 4, the respective soldering elements 460 may be chamfered soldering elements Chamfered soldering elements may have a chamfered configuration and/or may have flat angled upper surfaces.

The ambient light sensor 400 may therefore be aligned to sense light propagating through a light guide 470. The light guide 470 may be coupled to the flexible printed circuit 490 via an optical clear material layer 492. In some embodiments, the ambient light sensor 400 may be encapsulated by an optically transparent adhesive or other compound. For example, an optically clear adhesive may be disposed between the ambient light sensor 400 and the light guide 470, where the optically clear material functions as a light pipe to extract light from the light guide 470 and transfers the light to the ambient light sensor 400. Accordingly, the device may include an optically transparent material encapsulating the ambient light sensor 400 and/or otherwise disposed between the light guide 470 and the ambient light sensor 400. Due to the light guide acting as a light collector, the ambient light sensor 400 may have an angle of acceptance of between about 90 degrees and about 150 degrees, instead of being limited to 80 degrees like aperture-based ambient light sensors.

FIG. 5 is an example process flow and timeline for ambient light sensing using light guides in accordance with one or more embodiments of the disclosure. Other embodiments may implement different time periods and/or a different order of operations than that provided in the example of FIG. 5. Some of the operations in the process flow of FIG. 5 may be optional and/or may be performed in a different order. Certain operations may be performed by different components of an electronic device.

In an example timeline 500 presented in FIG. 5, relative values of LED current, sensor power supply, and sensor sampling are depicted over time. The pattern of the timeline 500 may be repeated periodically, such as every 15 milliseconds, every 16 milliseconds, every 20 milliseconds, or a different time period during device operation.

To sense ambient light using a device light guide, embodiments may periodically shut off LEDs coupled to the light guide, so as to allow the ambient light sensor to sense ambient light that propagates through the light guide. This is represented by the graph of the LED current in the timeline 500, where the current to the LEDs is shut off for a portion of the repetition period. However, perceivable flicker due to the LED current change may not be desirable, as a user experience with the device may be negatively impacted. Unlike pulse width modulation for LED intensity control, where low intensity and/or low duty cycle is more prone to perceivable flicker, embodiments may implement a fixed duty cycle at a relatively high value, such as a relatively high intensity of about 95%, such as about 92%, 93%, 94%, 96%, 97%, and so forth. The relatively high intensity may be combined with a repetition rate of, for example, at least 60 Hz, and a shut off period of 2 milliseconds or less. The combination of the relatively high intensity, repetition rate of at least 60 Hz, and short shut off period of 2 milliseconds or less, there may be no perceivable flicker. This is discussed further with respect to the Flicker-Free Repetition Rate graph of FIG. 6. Further, when the LED current is reduced to zero, such that the LEDs are shut off periodically, the average intensity of the LEDs will be reduced. The intensity relative to the constantly on LEDs are provided in percentage form on the Flicker-Free Repetition Rate graph of FIG. 6.

As shown in the timeline 500, the LED current may be shut off for a certain time period, such as about 2 milliseconds. At the same time the LED current is shut off, a power supply to the ambient light sensor may be turned on, such that the ambient light sensor receives current. The ambient light sensor power supply may be turned on for a slightly greater length of time than the LED current shut off period, so as to provide time for the ambient light sensor to initiate. In other embodiments, the LED current shut off and ambient light sensor power supply may be implemented for the same length of time and may overlap. The ambient light sensor may be sampled at the intervals depicted in the timeline 500. For example, the ambient light sensor may be sampled at or near the end of the “on” period for the sensor power supply. The ambient light sensor sampling may therefore represent approximately all of, or a majority of, the photons detected by the ambient light sensor during the time period the ambient light sensor was activated. After the ambient light sensor is sampled, the ambient light sensor may be deactivated and/or current supplied to the ambient light sensor may be shut off. The LED current may then be supplied at the relatively high intensity, such as over 90%. This process may be repeated during a time interval of, for example, 15 milliseconds, to allow for continuous ambient light measurements and corresponding changes to display brightness, thereby providing an improved user experience.

In an example process flow 510, a process for ambient light sensing using light guides is depicted. At block 520, current to LEDs of a device may be stopped. For example, a controller at a device may stop the flow of current to the LEDs adjacent to a light guide of the device. The light guide may therefore be unilluminated by the LEDs while the current is shut off.

At block 530, current may be provided to the ambient light sensor. The ambient light sensor may be disposed adjacent to the light guide, such as an edge surface of the light guide, and may be adjacent to one or more LEDs. Current may be provided to activate the ambient light sensor. Although depicted as discrete operations, current may be provided to the ambient light sensor before or during the current shut off process to the LEDs, so as to minimize time that the ambient light sensor is not fully activated after the LEDs are shut off.

At block 540, the ambient light sensor may be sampled. When the ambient light sensor is activated, the ambient light sensor may collect photons, or ambient light, representing light in an ambient environment of the device that has propagated through the light guide. Sampling of the ambient light sensor may provide a measurement of the photons that have been detected by the ambient light sensor. Accordingly, sampling of the ambient light sensor may occur at or near the time at which the ambient light sensor is deactivated via shut off of current or power supply.

At block 550, the current to the ambient light sensor may be stopped or shut off. After the ambient light sensor is sampled, the ambient light sensor may be turned off via shut off of power or current.

At block 560, current may be provided to the LEDs. The current may drive the LEDs at a relatively high intensity, such as 93%. The current may be provided at the same time, or slightly before, the current to the ambient light sensor is shut off.

The process flow 510 may then return to block 510 to repeat the process, such that the ambient light measurement can be continually updated and can accurately represent device ambient conditions. The shut off period for the LEDs, and/or the activation period for the ambient light sensor, may be about 2 milliseconds, and the entire process may be repeated every 15-20 milliseconds in some embodiments. Such time intervals may reduce a risk, or avoid, perceivable flicker at the device due to the LED shut off.

At optional block 570, ambient light sensor sample values may be accumulated. For example, the ambient light sensor sample values determined at the end of the ambient light sensor power supply activation time periods may be stored over a certain amount of time, such as a number of seconds, and/or until a certain number of measurements is completed. Ambient light sensor sample values may be stored for a certain length of time and/or until replaced by another ambient light sensor value.

At optional block 580, an ambient light measurement may be determined using the accumulated ambient light sensor sample values. In some embodiments, the ambient light sensor sample values may be averaged over time, or a moving average value may be determined. This may prevent rapid changes to display brightness or other device settings due to transient ambient light conditions.

FIG. 6 is a schematic illustration of a graph 600 illustrating a target relative intensity for displays, along with sample weighting values for ambient light sensing using light guides in accordance with one or more embodiments of the disclosure. The graph 600 illustrated in FIG. 6 corresponds to experimental test results.

The graph 600 presents a repetition rate in Hertz along a Y-axis and optical shut off pulse width along an X-axis in milliseconds. As can be seen on the graph 600, the longer the optical shut off pulse width, the higher the repetition rate should be in order to achieve flicker free performance. The lines presented on the graph 600 represent different current values for current provided to LEDs, and the percentage values represent a relative intensity percentage of the display. A relative intensity may be a measurement of display intensity (which may be determined using a luxometer, photometer, or other equipment, of a present display intensity relative to a display intensity in a preceding time interval, such as 15 milliseconds. A relative intensity of 100% indicates that there has been no change in display intensity, whereas a relative intensity of 50% indicates that there has been a 50% reduction in display intensity.

For optimal performance, the display should appear flicker free, and should also have low LED intensity loss. At a current of 25 milliamps, depending on the repetition rate, a flicker free appearance can be achieved across the different optical shut off pulse widths. For example, at a 1 millisecond optical shut off pulse width, a repetition rate of between 55 and 60 Hz and current of 25 mA will result in flicker free performance Similarly, at a 2 millisecond optical shut off pulse width, a repetition rate of about 60 Hz and current of 25 mA will result in flicker free performance. At a 4 millisecond optical shut off pulse width, a repetition rate of between 70 and 80 Hz and current of 25 mA will result in flicker free performance, and so forth.

However, low LED intensity loss may be desired in addition to flicker free performance. Accordingly, using the graph 600, it may be determined that at an optical shut off pulse width of between 1 millisecond and 1.5 milliseconds, a repetition rate of between about 58 and 65 Hz and current of 25 mA provides not only flicker free performance, but low LED intensity loss as well, where a relative intensity of 94.4% can be achieved. This provides an optimal user experience while also allowing for ambient light sensing using light guides. Accordingly, settings of an optical shut off pulse width of about 1 millisecond, a repetition rate of between about 62 Hz and current of 25 mA may be optimal for both a user experience and ambient light sensing. Although other settings may provide flicker free performance, a relative intensity may not be high enough, resulting in a relatively high LED intensity loss. Some embodiments may therefore include ambient light sensors configured to measure ambient light measurements while the device maintains a relative intensity of at least 85%.

Some embodiments may implement a fixed duty cycle at a relatively high value, such as a relatively high intensity of about 94-95%. The relatively high intensity may be combined with a repetition rate of, for example, at least 60 Hz, and a shut off period of 1 millisecond. The combination of the relatively high intensity, repetition rate of at least 60 Hz, and short shut off period of 1 millisecond, there may be no perceivable flicker. When the LED current is reduced to zero, such that the LEDs are shut off periodically, the average intensity will be reduced, but the relative intensity is maintained at about 94%.

For sampling time periods, ambient light sensing may be sampled over a time interval of about 1 millisecond. Many indoor lighting sources, such as incandescent lights, lights using a dimmer, LED lamps, etc., carry alternating current ripples in the light intensity. Unlike conventional ambient light sensors, which use a long exposure time (e.g., 100 milliseconds or more) to average out the ripple, embodiments may sample ambient light for a short period (e.g., 1 millisecond). Sub-sampling can be used to average values, so as to achieve alternating current rejection. Some embodiments may use subsampling intervals of 15 ms and 66.67 Hz repetition rate, 16 ms and 62.5 Hz repetition rate, or another suitable subsampling interval.

In FIG. 6, a device 610 with a display and an ambient light sensor 620 is depicted. The ambient light sensor 620 is depicted in an example position. Other devices may have ambient light sensors in different positions. The ambient light sensor 620 may be optically coupled to a light guide of the device 610, and may be configured to measure ambient light via light propagating through the light guide.

Different portions of a display device may contribute different attenuation, which may lead to image dependency of coupling efficiency. Ink absorbs light in the light guide. As a result, coupling efficiency becomes a function of the ink density across the display, and can be dependent on images presented at the display. The area nearest where the ambient light sensor 620 is located may the smallest attenuation. For example, the area of the display labeled Zone 1 in FIG. 6 may have the smallest attenuation. Zone 2 may have slightly larger attenuation, and Zone 3 may have the largest attenuation. To equalize the optical coupling efficiency for arbitrary images, the display can be segmented into different zones or cells. The contribution to the total light transmittance of each and/or zone can be used to weight different cells differently. Accordingly, the weight of the different zones or segments may be used as a compensation factor to calibrate the ambient light sensor 620 for more accurate ambient light measurements.

One or more operations of the methods, process flows, or use cases of FIGS. 1-6 may have been described above as being performed by a user device, or more specifically, by one or more program module(s), applications, or the like executing on a device. It should be appreciated, however, that any of the operations of the methods, process flows, or use cases of FIGS. 1-6 may be performed, at least in part, in a distributed manner by one or more other devices, or more specifically, by one or more program module(s), applications, or the like executing on such devices. In addition, it should be appreciated that processing performed in response to the execution of computer-executable instructions provided as part of an application, program module, or the like may be interchangeably described herein as being performed by the application or the program module itself or by a device on which the application, program module, or the like is executing. While the operations of the methods, process flows, or use cases of FIGS. 1-6 may be described in the context of the illustrative devices, it should be appreciated that such operations may be implemented in connection with numerous other device configurations.

The operations described and depicted in the illustrative methods, process flows, and use cases of FIGS. 1-6 may be carried out or performed in any suitable order, such as the depicted orders, as desired in various example embodiments of the disclosure. Additionally, in certain example embodiments, at least a portion of the operations may be carried out in parallel. Furthermore, in certain example embodiments, less, more, or different operations than those depicted in FIGS. 1-6 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by the execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

### Illustrative Computer Architecture

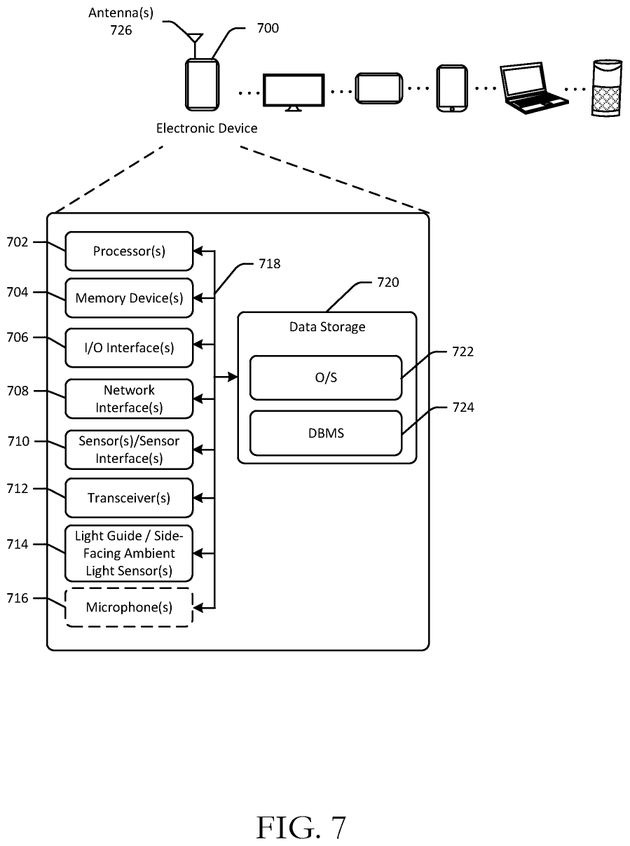

FIG. 7 is a schematic block diagram of one or more illustrative electronic device(s) 700 in accordance with one or more example embodiments of the disclosure. The electronic device(s) 700 may include any suitable computing device including, but not limited to, a server system, a mobile device such as a smartphone, a tablet, an e-reader, a wearable device, or the like; a desktop computer; a laptop computer; a content streaming device; a set-top box; a scanning device; a barcode scanner; or the like. The electronic device(s) 700 may correspond to an illustrative device configuration for the device(s) of FIGS. 1-6.

The electronic device(s) 700 may be configured to communicate with one or more servers, user devices, or the like. The electronic device(s) 700 may be configured to determine voice commands, determine wakeword utterances, present digital content, determine and/or control other devices, and other operations.

The electronic device(s) 700 may be configured to communicate via one or more networks. Such network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the electronic device(s) 700 may include one or more processors (processor(s)) 702, one or more memory devices 704 (also referred to herein as memory 704), one or more input/output (I/O) interface(s) 706, one or more network interface(s) 708, one or more sensor(s) or sensor interface(s) 710, one or more transceiver(s) 712, one or more light guides/side-facing ambient light sensor(s) 714, one or more optional microphone(s) 716, and data storage 720. The electronic device(s) 700 may further include one or more bus(es) 718 that functionally couple various components of the electronic device(s) 700. The electronic device(s) 700 may further include one or more antenna(s) 726 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 718 may include at least one of a system bus, a memory bus, an address bus, or a message bus, and may permit the exchange of information (e.g., data (including computer-executable code), signaling, etc.) between various components of the electronic device(s) 700. The bus(es) 718 may include, without limitation, a memory bus or a memory controller, a peripheral bus, an accelerated graphics port, and so forth. The bus(es) 718 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnect (PCI) architecture, a PCI-Express architecture, a Personal Computer Memory Card International Association (PCMCIA) architecture, a Universal Serial Bus (USB) architecture, and so forth.

The memory 704 of the electronic device(s) 700 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 704 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 704 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 720 may include removable storage and/or non-removable storage including, but not limited to, magnetic storage, optical disk storage, and/or tape storage. The data storage 720 may provide non-volatile storage of computer-executable instructions and other data. The memory 704 and the data storage 720, removable and/or non-removable, are examples of computer-readable storage media (CRSM) as that term is used herein.

The data storage 720 may store computer-executable code, instructions, or the like that may be loadable into the memory 704 and executable by the processor(s) 702 to cause the processor(s) 702 to perform or initiate various operations. The data storage 720 may additionally store data that may be copied to the memory 704 for use by the processor(s) 702 during the execution of the computer-executable instructions. Moreover, output data generated as a result of execution of the computer-executable instructions by the processor(s) 702 may be stored initially in the memory 704, and may ultimately be copied to the data storage 720 for non-volatile storage.

More specifically, the data storage 720 may store one or more operating systems (O/S) 722; one or more database management systems (DBMS) 724; and one or more program module(s), applications, engines, computer-executable code, scripts, or the like. Some or all of these module(s) may be sub-module(s). Any of the components depicted as being stored in the data storage 720 may include any combination of software, firmware, and/or hardware. The software and/or firmware may include computer-executable code, instructions, or the like that may be loaded into the memory 704 for execution by one or more of the processor(s) 702. Any of the components depicted as being stored in the data storage 720 may support functionality described in reference to corresponding components named earlier in this disclosure.

The data storage 720 may further store various types of data utilized by the components of the electronic device(s) 700. Any data stored in the data storage 720 may be loaded into the memory 704 for use by the processor(s) 702 in executing computer-executable code. In addition, any data depicted as being stored in the data storage 720 may potentially be stored in one or more datastore(s) and may be accessed via the DBMS 724 and loaded in the memory 704 for use by the processor(s) 702 in executing computer-executable code. The datastore(s) may include, but are not limited to, databases (e.g., relational, object-oriented, etc.), file systems, flat files, distributed datastores in which data is stored on more than one node of a computer network, peer-to-peer network datastores, or the like.

The processor(s) 702 may be configured to access the memory 704 and execute the computer-executable instructions loaded therein. For example, the processor(s) 702 may be configured to execute the computer-executable instructions of the various program module(s), applications, engines, or the like of the electronic device(s) 700 to cause or facilitate various operations to be performed in accordance with one or more embodiments of the disclosure. The processor(s) 702 may include any suitable processing unit capable of accepting data as input, processing the input data in accordance with stored computer-executable instructions, and generating output data. The processor(s) 702 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 702 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 702 may be capable of supporting any of a variety of instruction sets.

Referring now to other illustrative components depicted as being stored in the data storage 720, the O/S 722 may be loaded from the data storage 720 into the memory 704 and may provide an interface between other application software executing on the electronic device(s) 700 and the hardware resources of the electronic device(s) 700. More specifically, the O/S 722 may include a set of computer-executable instructions for managing the hardware resources of the electronic device(s) 700 and for providing common services to other application programs (e.g., managing memory allocation among various application programs). In certain example embodiments, the O/S 722 may control execution of the other program module(s). The O/S 722 may include any operating system now known or which may be developed in the future including, but not limited to, any server operating system, any mainframe operating system, or any other proprietary or non-proprietary operating system.

The DBMS 724 may be loaded into the memory 704 and may support functionality for accessing, retrieving, storing, and/or manipulating data stored in the memory 704 and/or data stored in the data storage 720. The DBMS 724 may use any of a variety of database models (e.g., relational model, object model, etc.) and may support any of a variety of query languages. The DBMS 724 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like. In those example embodiments in which the electronic device(s) 700 is a mobile device, the DBMS 724 may be any suitable lightweight DBMS optimized for performance on a mobile device.

Referring now to other illustrative components of the electronic device(s) 700, the input/output (I/O) interface(s) 706 may facilitate the receipt of input information by the electronic device(s) 700 from one or more I/O devices as well as the output of information from the electronic device(s) 700 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the electronic device(s) 700 or may be separate. The I/O devices may further include, for example, any number of peripheral devices such as data storage devices, printing devices, and so forth.

The I/O interface(s) 706 may also include an interface for an external peripheral device connection such as universal serial bus (USB), FireWire, Thunderbolt, Ethernet port or other connection protocol that may connect to one or more networks. The I/O interface(s) 706 may also include a connection to one or more of the antenna(s) 726 to connect to one or more networks via a wireless local area network (WLAN) (such as Wi-Fi) radio, Bluetooth, ZigBee, and/or a wireless network radio, such as a radio capable of communication with a wireless communication network such as a Long Term Evolution (LTE) network, WiMAX network, 3G network, a ZigBee network, etc.

The electronic device(s) 700 may further include one or more network interface(s) 708 via which the electronic device(s) 700 may communicate with any of a variety of other systems, platforms, networks, devices, and so forth. The network interface(s) 708 may enable communication, for example, with one or more wireless routers, one or more host servers, one or more web servers, and the like via one or more networks.

The antenna(s) 726 may include any suitable type of antenna depending, for example, on the communications protocols used to transmit or receive signals via the antenna(s) 726. Non-limiting examples of suitable antennas may include directional antennas, non-directional antennas, dipole antennas, folded dipole antennas, patch antennas, multiple-input multiple-output (MIMO) antennas, or the like. The antenna(s) 726 may be communicatively coupled to one or more transceivers 712 or radio components to which or from which signals may be transmitted or received.

As previously described, the antenna(s) 726 may include a cellular antenna configured to transmit or receive signals in accordance with established standards and protocols, such as Global System for Mobile Communications (GSM), 3G standards (e.g., Universal Mobile Telecommunications System (UMTS), Wideband Code Division Multiple Access (W-CDMA), CDMA2000, etc.), 4G standards (e.g., Long-Term Evolution (LTE), WiMax, etc.), direct satellite communications, or the like.

The antenna(s) 726 may additionally, or alternatively, include a Wi-Fi antenna configured to transmit or receive signals in accordance with established standards and protocols, such as the IEEE 802.11 family of standards, including via 2.4 GHz channels (e.g., 802.11b, 802.11g, 802.11n), 5 GHz channels (e.g., 802.11n, 802.11ac), or 60 GHz channels (e.g., 802.11ad). In alternative example embodiments, the antenna(s) 726 may be configured to transmit or receive radio frequency signals within any suitable frequency range forming part of the unlicensed portion of the radio spectrum.

The antenna(s) 726 may additionally, or alternatively, include a GNSS antenna configured to receive GNSS signals from three or more GNSS satellites carrying time-position information to triangulate a position therefrom. Such a GNSS antenna may be configured to receive GNSS signals from any current or planned GNSS such as, for example, the Global Positioning System (GPS), the GLONASS System, the Compass Navigation System, the Galileo System, or the Indian Regional Navigational System.

The transceiver(s) 712 may include any suitable radio component(s) for—in cooperation with the antenna(s) 726—transmitting or receiving radio frequency (RF) signals in the bandwidth and/or channels corresponding to the communications protocols utilized by the electronic device(s) 700 to communicate with other devices. The transceiver(s) 712 may include hardware, software, and/or firmware for modulating, transmitting, or receiving—potentially in cooperation with any of antenna(s) 726—communications signals according to any of the communications protocols discussed above including, but not limited to, one or more Wi-Fi and/or Wi-Fi direct protocols, as standardized by the IEEE 802.11 standards, one or more non-Wi-Fi protocols, or one or more cellular communications protocols or standards. The transceiver(s) 712 may further include hardware, firmware, or software for receiving GNSS signals. The transceiver(s) 712 may include any known receiver and baseband suitable for communicating via the communications protocols utilized by the electronic device(s) 700. The transceiver(s) 712 may further include a low noise amplifier (LNA), additional signal amplifiers, an analog-to-digital (A/D) converter, one or more buffers, a digital baseband, or the like.

The sensor(s)/sensor interface(s) 710 may include or may be capable of interfacing with any suitable type of sensing device such as, for example, inertial sensors, force sensors, thermal sensors, photocells, and so forth. Example types of inertial sensors may include accelerometers (e.g., MEMS-based accelerometers), gyroscopes, and so forth.

The light guides/side-facing ambient light sensor(s) 714 may be one or more side-sensing or side-facing ambient light sensors optically coupled to a light guide, such that the light guide acts as a light collector for ambient light measurements determined by the ambient light sensor as described herein, such as those described in conjunction with FIGS. 1-6. The microphone(s) 716 may be any device configured to receive analog sound input or voice data.

It should be appreciated that the program module(s), applications, computer-executable instructions, code, or the like depicted in FIG. 7 as being stored in the data storage 720 are merely illustrative and not exhaustive and that processing described as being supported by any particular module may alternatively be distributed across multiple module(s) or performed by a different module. In addition, various program module(s), script(s), plug-in(s), Application Programming Interface(s) (API(s)), or any other suitable computer-executable code hosted locally on the electronic device(s) 700, and/or hosted on other computing device(s) accessible via one or more networks, may be provided to support functionality provided by the program module(s), applications, or computer-executable code depicted in FIG. 7 and/or additional or alternate functionality. Further, functionality may be modularized differently such that processing described as being supported collectively by the collection of program module(s) depicted in FIG. 7 may be performed by a fewer or greater number of module(s), or functionality described as being supported by any particular module may be supported, at least in part, by another module. In addition, program module(s) that support the functionality described herein may form part of one or more applications executable across any number of systems or devices in accordance with any suitable computing model such as, for example, a client-server model, a peer-to-peer model, and so forth. In addition, any of the functionality described as being supported by any of the program module(s) depicted in FIG. 7 may be implemented, at least partially, in hardware and/or firmware across any number of devices.

It should further be appreciated that the electronic device(s) 700 may include alternate and/or additional hardware, software, or firmware components beyond those described or depicted without departing from the scope of the disclosure. More particularly, it should be appreciated that software, firmware, or hardware components depicted as forming part of the electronic device(s) 700 are merely illustrative and that some components may not be present or additional components may be provided in various embodiments. While various illustrative program module(s) have been depicted and described as software module(s) stored in the data storage 720, it should be appreciated that functionality described as being supported by the program module(s) may be enabled by any combination of hardware, software, and/or firmware. It should further be appreciated that each of the above-mentioned module(s) may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other module(s). Further, one or more depicted module(s) may not be present in certain embodiments, while in other embodiments, additional module(s) not depicted may be present and may support at least a portion of the described functionality and/or additional functionality. Moreover, while certain module(s) may be depicted and described as sub-module(s) of another module, in certain embodiments, such module(s) may be provided as independent module(s) or as sub-module(s) of other module(s).

Program module(s), applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

That which is claimed is:

1. An electronic device comprising:
a housing;
a light emitting diode configured to emit light;
a display stack coupled to the housing, the display stack comprising:
a reflective display;
a light guide coupled to the reflective display, the light guide configured to propagate ambient light and the light emitted by the light emitting diode, wherein the light emitting diode is optically coupled to an edge surface of the light guide;
a touch sensor layer configured to receive touch input, the touch sensor layer disposed on the light guide; and
a cover layer disposed on the touch sensor layer; and
an ambient light sensor configured to detect the ambient light that propagates through the light guide, wherein the ambient light sensor is disposed adjacent to the light emitting diode and is optically coupled to the edge surface of the light guide, such that the ambient light sensor, the light emitting diode, and the light guide are arranged in a coplanar arrangement, and wherein the ambient light sensor is configured to detect ambient light at an angle of acceptance of between about 90 degrees and about 150 degrees.

2. The electronic device of claim 1, further comprising:
a flexible printed circuit, wherein the light emitting diode is disposed on the flexible printed circuit;
wherein the ambient light sensor comprises:
a lower surface in contact with the flexible printed circuit; and
a side surface comprising a sensing area and a plurality of solder pads, wherein the ambient light sensor is electrically coupled to the flexible printed circuit using soldering disposed between the respective plurality of solder pads and the flexible printed circuit, the soldering having a chamfered configuration.

3. The electronic device of claim 1, further comprising:
an optically transparent compound encapsulating the ambient light sensor and disposed between the light guide and the ambient light sensor, such that light propagates through the optically transparent compound.

4. The electronic device of claim 1, further comprising:
a bezel coupled to the housing and disposed about the display stack, wherein the bezel is devoid of any apertures.

5. A device comprising:
a cover layer;
a light guide;
a light emitting diode disposed adjacent to an edge surface of the light guide; and
an ambient light sensor disposed adjacent to the light emitting diode;
wherein the ambient light sensor is configured to sense ambient light that propagates through the cover layer and the light guide.

6. The device of claim 5, wherein the ambient light sensor is a side-sensing ambient light sensor, and wherein the light emitting diode is a side-firing light emitting diode.

7. The device of claim 5, further comprising:
a flexible printed circuit;
wherein the ambient light sensor comprises:
a lower surface in contact with the flexible printed circuit; and
a side surface comprising a sensing area.

8. The device of claim 7, wherein the ambient light sensor further comprises a plurality of solder pads, and wherein the ambient light sensor is electrically coupled to the flexible printed circuit using soldering elements disposed between the respective plurality of solder pads and the flexible printed circuit.

9. The device of claim 7, wherein the light emitting diode is disposed on the flexible printed circuit, and the ambient light sensor is attached to the flexible printed circuit.

10. The device of claim 5, further comprising:
an optically transparent material disposed between the light guide and the ambient light sensor.

11. The device of claim 5, wherein the ambient light sensor is configured to measure ambient light measurements while the device maintains a relative intensity of at least 70%.

12. The device of claim 5, further comprising:
a reflective display layer coupled to the light guide.

13. The device of claim 5, wherein the ambient light sensor has an angle of acceptance of between about 90 degrees and about 150 degrees.

14. The device of claim 5, further comprising:
a housing; and
a bezel coupled to the housing, wherein the bezel is devoid of apertures.

15. A device comprising:
a display stack comprising:
a cover layer;
a light guide; and
a light emitting diode disposed adjacent to an edge surface of the light guide; and
an ambient light sensor;
wherein the ambient light sensor is configured to sense ambient light that propagates through the cover layer and the light guide.

16. The device of claim 15, wherein the ambient light sensor is a side-sensing ambient light sensor, and wherein the light emitting diode is a side-firing light emitting diode.

17. The device of claim 15, further comprising:
a flexible printed circuit, wherein the light emitting diode is disposed on the flexible printed circuit;
wherein the ambient light sensor comprises:
a lower surface in contact with the flexible printed circuit; and
a side surface comprising a sensing area and a plurality of solder pads.

18. The device of claim 17, wherein the ambient light sensor is electrically coupled to the flexible printed circuit using soldering elements disposed between the respective plurality of solder pads and the flexible printed circuit.

19. The device of claim 15, further comprising:
an optically transparent material encapsulating the ambient light sensor and disposed between the light guide and the ambient light sensor.

20. The device of claim 15, wherein the ambient light sensor is configured to measure ambient light measurements while the device maintains a relative intensity of at least 70%.
